(19) United States
(12) Patent Application Publication
(10) Pub. No.: US 2022/0229546 A1
(43) Pub. Date: Jul. 21, 2022

(54) ELECTRONIC DEVICE AND METHOD FOR OPERATING AVATA VIDEO SERVICE IN THE SAME

(71) Applicant: Samsung Electronics Co., Ltd., Gyeonggi-do (KR)

(72) Inventors: Minkyung LEE, Gyeonggi-do (KR); Dongsoo SHIN, Gyeonggi-do (KR); Yunjae LEE, Gyeonggi-do (KR); Jinsoo JANG, Gyeonggi-do (KR); Miji PARK, Gyeonggi-do (KR); Donghwan BAE, Gyeonggi-do (KR); Sanga YOO, Gyeonggi-do (KR); Kyuho LEE, Gyeonggi-do (KR); Hyeonju LEE, Gyeonggi-do (KR); Jina CHOE, Gyeonggi-do (KR)

(21) Appl. No.: 17/679,748

(22) Filed: Feb. 24, 2022

Related U.S. Application Data
(63) Continuation of application No. PCT/KR2022/000408, filed on Jan. 11, 2022.

(30) Foreign Application Priority Data
Jan. 13, 2021 (KR) 10-2021-0004702

(51) Int. Cl. G06F 3/04847; G06T 13/40; G06F 3/0482; G06F 3/04845; G06F 3/16

(52) U.S. Cl. CPC G06F 3/04847; G06T 13/40; G06T 2200/24; G06F 3/04845; G06F 3/165; G06F 3/0482

(57) ABSTRACT

An electronic device and method are disclosed. The electronic device includes: a display, a processor, input circuitry, and memory. The processor may implement the method, including: executing an avatar service application as part of a video avatar mode, and displaying a user interface of the avatar service application, including a plurality of screen setting categories, detecting selection of a first screen setting category from among the plurality, and based on the detected selection, displaying an avatar video list including a plurality of avatar videos, and based on detecting selection of a first avatar video among the avatar video list, applying the first avatar video to a screen of the selected first screen setting category, wherein each avatar video is composed based on a template combined with at least a sound, a background, and an arrangement of a stored digital avatar as recommended for a first animation.

### CROSS-REFERENCE TO RELATED APPLICATION(S)

This application is a continuation of International Application No. PCT/KR2022/000408, filed on Jan. 11, 2022, which claims priority to Korean Patent Application No. 10-2021-0004702, filed on Jan. 13, 2021 in the Korean Intellectual Property Office, the disclosures of which are herein incorporated by reference.

### TECHNICAL FIELD

Certain embodiments relate to an electronic device and an avatar video service operating method.

### BACKGROUND

Some electronic devices may generate avatars, or abstract digital representations of a user. Avatars may sometimes be generated algorithmically from an image of the user captured via a camera. While some avatars are 2-dimensional, others can be 3-dimensional (e.g., polygonal). The avatars may be modified as well, to incorporate display of, for example, facial expressions, animated motions, or text bubbles, etc., which may give the digital avatar a range of possible expressions. An avatar service function (e.g., and/or an emoji service function) may thus be provided by the electronic device, having a variety of possible uses by a user.

The usage of avatars may be restricted with respect to certain media or application contexts, and furthermore, the implementations of avatars may not be sufficiently flexible to accommodate a user's desired expressions or usages thereof.

### SUMMARY

Certain embodiments of the disclosure may provide an environment in which an avatar video (e.g., or an avatar video package) may be generated and output, by algorithmic recommendations of sound sources and background images for combination with an animated avatar, as part of an avatar service.

An electronic device electronic device according to certain embodiments may include a display, a processor, input circuitry, and memory. The processor may implement the method, including: executing an avatar service application as part of a video avatar mode, and displaying a user interface of the avatar service application, including a plurality of screen setting categories, detecting selection of a first screen setting category from among the plurality, and based on the detected selection, displaying an avatar video list including a plurality of avatar videos, and based on detecting selection of a first avatar video among the avatar video list, applying the first avatar video to a screen of the selected first screen setting category, wherein each avatar video is composed based on a template combined with at least a sound, a background, and an arrangement of a stored digital avatar as recommended for a first animation.

A method for operating an avatar video service of an electronic device according to certain embodiments may include executing, by at least one processor, an avatar service application as part of a video avatar mode, and displaying, via a display, a user interface of the avatar service application, including a plurality of screen setting categories, detecting, via input circuitry, selection of a first screen setting category from among the plurality, and based on the detected selection, displaying an avatar video list including a plurality of avatar videos , and based on detecting selection of a first avatar video template from among the avatar video list, applying the first avatar video to the a screen of the selected first screen setting category, wherein each avatar video is composed based on a template combined with at least a sound, a background, and an arrangement of a stored digital avatar as recommended for a first animation.

According to certain embodiments, an avatar video may be algorithmically generated by combining multiple multimedia elements, such as, for example, avatar animations, digital image background, sound effects and music. These may be provided within a singular avatar service. Further, the avatar video may be as part of increasing the aesthetic function of a smartphone, thereby improving the user experience of the smartphone and the digital avatar.

According to certain embodiments, elements of a generated avatar video may be further altered to reflection application settings, screen configurations, or functional contexts of the device, etc., thereby providing the user with a highly customizable, contextualized avatar service.

### BRIEF DESCRIPTION OF DRAWINGS

FIG. 1 is a block diagram illustrating an electronic device 101 in a network environment 100 according to certain embodiments.

FIG. 2 illustrates a method for operating an avatar video service of an electronic device according to certain embodiments.

FIG. 3 illustrates user interface screens related to an avatar video service of an electronic device according to an embodiment.

FIG. 4 is a flowchart illustrating an avatar video configuration operation in an electronic device according to an embodiment.

FIG. 5 is an example diagram illustrating providing of an avatar video list of an electronic device according to an embodiment.

FIG. 6 is a flowchart illustrating an avatar video generation and editing operation of an electronic device according to an embodiment.

FIG. 7 illustrates an avatar video editing user interface environment of an electronic device according to an embodiment.

FIG. 8 illustrates an avatar video editing user interface environment of an electronic device according to an embodiment.

FIG. 9 illustrates an avatar video editing user interface environment of an electronic device according to an embodiment.

FIG. 10 illustrates an avatar video editing user interface environment of an electronic device according to an embodiment.

FIG. 11 is a context diagram illustrating an avatar service operation of an electronic device according to certain embodiments.

FIG. 12 is a flowchart illustrating an operation of customizing an avatar video according to a user context of an electronic device according to certain embodiments.

FIG. 13 illustrates an avatar video user interface environment of an electronic device according to certain embodiments.

FIG. 14 illustrates an avatar video user interface environment of an electronic device according to certain embodiments.

FIG. 15 illustrates an avatar video user interface environment of an electronic device according to certain embodiments.

FIG. 16 illustrates an avatar video user interface environment of an electronic device according to certain embodiments.

FIG. 17 illustrates an avatar video user interface environment of an electronic device according to certain embodiments.

FIG. 18 illustrates an avatar video user interface environment of an electronic device according to certain embodiments.

FIG. 19 illustrates an avatar video user interface environment of an electronic device according to certain embodiments.

### DETAILED DESCRIPTION

The electronic device according to certain embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

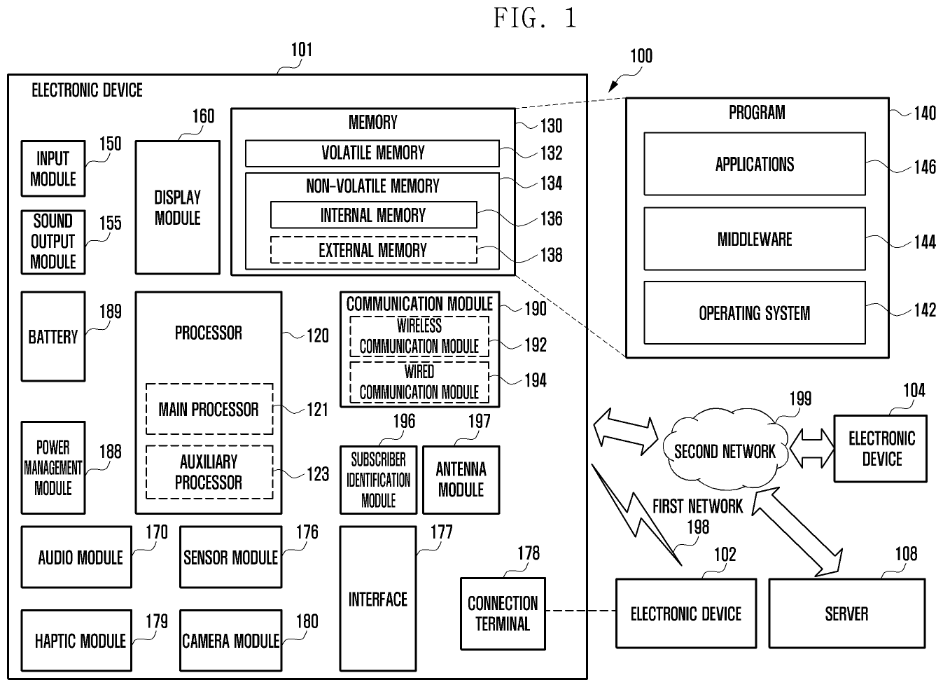

FIG. 1 is a block diagram illustrating an electronic device in a network environment according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module(SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as BluetoothTM, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element implemented using a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to certain embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band. At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra-low-latency services using, e.g., distributed computing or mobile edge computing. In another embodiment, the external electronic device 104 may include an intemet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

According to an embodiment, the memory 130 may store data related to an avatar video service. The memory 130 may store various instructions that may be executed by the processor 120.

According to an embodiment, the processor 120 may provide a user interface environment for supporting the performance of a function related to an avatar video (or an avatar video package or avatar video content) including a plurality of elements such as a motion, a background source, and a sound source in the avatar service through the display device 160 (e.g., a touch screen display including a touch circuit). The processor 120 may provide, to a user through the user interface environment, a function of recognizing an object (e.g., a user) from an image, a function of generating an avatar replacing a user, a function of generating an avatar video by recommending a suitable background source and music for each avatar motion, and a function of configuring a screen related to an avatar video.

In an embodiment, the processor 120 may generate (or produce) an avatar video based on an avatar video template that configures a motion, a background source, and a sound source in the form of one package. For example, the electronic device 101 may download a template that supports recommending and providing a background source and a sound source for each motion (e.g., a background source and a sound source are recommended by the electronic device according to a motion), and may analyze music and a background source database (e.g., a memory or server) to recommend a sound source and a background source matching each motion, and may generate and store an avatar video including the recommended sound source and background source together with the motion. In another embodiment, the electronic device 101 may download a pre-produced avatar video (or an avatar video package) through a server and provide the same to a user through a user interface environment.

Hereinafter, an avatar video service function supported by the electronic device 101 will be described in detail, and operations of the processor 120 to be described later may be performed by loading instructions stored in the memory 130.

The electronic device 101 according to certain embodiments may include a display, a processor 120, and a memory 130, such that the memory 130 includes instructions causing the processor 120 to, when an avatar service is executed, provide a screen setting category in an avatar video mode, provide an avatar video list obtained by combining at least one of a sound source, a background source, and an avatar arrangement structure, which are recommended for each avatar motion, in response to selection of a first screen setting category in the screen setting category, and configure a screen of the selected first screen setting category such that a first avatar video is reproduced, in response to selection of the first avatar video from the avatar video list.

The memory 130 according to certain embodiments may further include instructions causing the processor 120 to configure an avatar video by combining a sound source and a background source for each motion based on an avatar video template configured to include a motion, a sound source, and a background source, and provide the avatar video list in the form of a thumbnail.

The memory 130 according to certain embodiments may further include instructions causing the processor 120 to recommend a sound source suitable for each motion by comparing each piece of motion information stored in the memory 130 with a sound source database stored in the memory, recommend a background source image suitable for motion information stored in the memory from an image database stored in the memory, and provide an avatar video obtained by combining the recommended sound source and background source image to the avatar video list.

The memory 130 according to certain embodiments may further include instructions causing the processor 120 to provide an avatar video package, to which music and a background source recommended for each motion are automatically applied, to the avatar video list from a server.

The screen setting category according to certain embodiments may include at least one of a call screen setting item, a lock screen setting item, a reminder notification screen setting item, a background source screen setting item, an alarm screen setting item, and a sharing setting item, and the memory 130 may further include instructions causing the processor 120 to enter an individual setting mode selected in response to a user input for entering an individual setting mode for each screen setting category, and configure each screen for each selected avatar video.

The memory 130 according to certain embodiments may further include instructions causing the processor 120 to recommend one sound source through at least one of selection of a sound source matching beats per minute (bpm) information of each motion, selection of a sound source corresponding to a music genre theme of each motion, or selection of a sound source matching identification information of each motion, and select and recommend a sound source having a higher priority based on at least one of sound source preference, metadata comparison order, and the number of times of reproductions when multiple sound sources are recommended.

The memory 130 according to certain embodiments may further include instructions causing the processor 120 to identify the size of the display, identify a spatial region in which an avatar is to be displayed according to the display size, and change and display the size and position of an avatar to be displayed when the avatar video is reproduced based on the spatial region.

The memory 130 according to certain embodiments may further include instructions causing the processor 120 to provide an avatar editing function in the first avatar video reproduce mode, and perform at least one of adjustment of the size and position of an avatar through the avatar editing function according to a user request, changing of a sound source recommended in the first avatar video, or editing and changing of a background source recommended in the first avatar video.

The memory 130 according to certain embodiments may further include instructions causing the processor 120 to, when an avatar video is configured in association with a lock screen or a background source screen, activate a mute function.

The memory 130 according to certain embodiments may further include instructions causing the processor 120 to, when a screen on which an avatar video is configured is displayed, display user interface objects arranged on the screen by adjusting the size and position of an avatar included in the avatar video or adjusting the size and position of a background source according to positions thereof.

The memory 130 according to certain embodiments may further include instructions causing the processor 120 to, when a screen on which an avatar video is configured is displayed, display the screen by analyzing a usage context of the electronic device, performing a mute activation function, adjusting the size and position of the avatar included in the avatar video, or adjusting the size and position of the background source according to the context situation.

The memory 130 according to certain embodiments may further include instructions causing the processor 120 to, when a screen on which an avatar video is configured is displayed, change an avatar costume, a background source, and accessories included in an avatar video, which is configured according to time information, position information, and schedule information, to other optimized items and display the same.

The memory 130 according to certain embodiments may further include instructions causing the processor 120 to provide a new avatar video generation item in the avatar video mode and provide the avatar video list based on selection of the new avatar video generation item, and in response to storing a second avatar video selected from the avatar video list, provide sharing items and setting category items for configuring the second avatar video.

The memory 130 according to certain embodiments may further include instructions causing the processor 120 to provide a new avatar video generation item in the avatar video mode and provide a motion list based on selection of the new avatar video generation item, in response to selection of a first motion from the motion list, reproduce a second avatar video obtained by combining a background source and music, which are recommended in response to the first motion, and in response to storing the second avatar video, provide sharing items and setting category items for configuring the second avatar video.

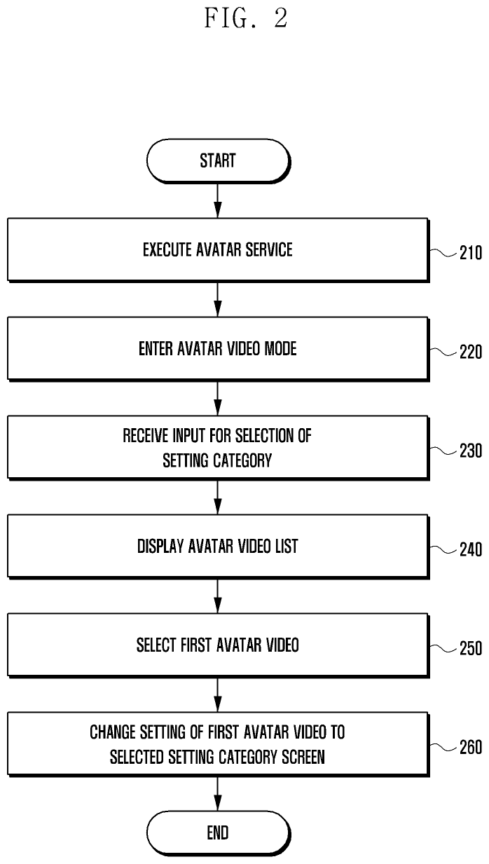

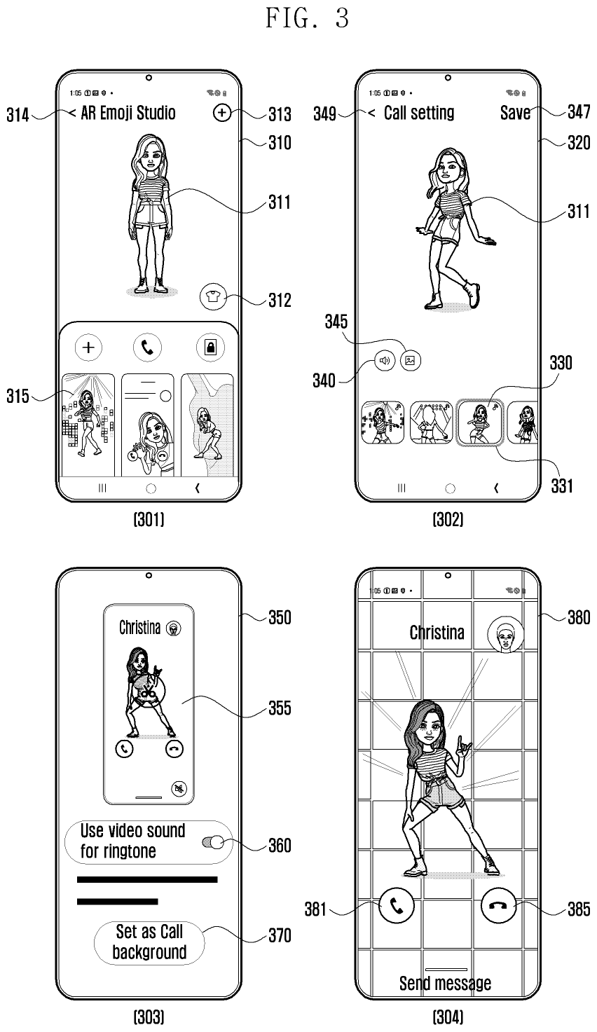

FIG. 2 illustrates a method for operating an avatar video service of an electronic device according to certain embodiments, and FIG. 3 illustrates user interface screens related to an avatar video service of an electronic device according to an embodiment.

Referring to FIGS. 2 and 3, a processor (e.g., the processor 120 of FIG. 1) of the electronic device 101 according to an embodiment may execute an avatar service installed in the electronic device 101 in operation 210.

For example, when a user selects an avatar application (e.g., via touch selection to an avatar animation app or an augmented reality app), the avatar-related application may be executed. The avatar application may support functions related to a digital avatar character, an emoji/animated sticker, and an avatar video. Functions supported by the avatar application may be provided as one of the camera functions (e.g., an app within an app).

In operation 220, the processor 120 may enter an avatar video mode in response to detecting a user input requesting entry into an avatar video mode.

In response to entering the avatar video mode, the processor 120 may output, to the display, an avatar video user interface (UI) environment for supporting various functions related to an avatar video. The avatar video mode may support a variety of functions related to the avatar video, including display, editing, configuration, generation and sharing functions.

As an example, as shown in <301>, the processor 120 may display a first screen 310 including a categorical list of settings 315 in an avatar “showroom” digital environment in which an avatar 311 is displayed for review by a user. The first screen 310 may include a selected avatar 311, an item 312 selectable to change stylistic elements of the avatar (e.g., clothes and hair), and add-avatar item 313 selectable to generate an additional avatar, and a cancel item 314 selectable to cancel the avatar configuration and return to a previous screen (e.g., or preceding function).

The setting category list 315 may include a variety of video templates that can be categorically set for the avatar in the avatar video mode. Categories included therein may include call screen settings, alarm screen settings, background source settings, lock screen settings, sharing settings, and/or music playback screen settings for example, but are not limited thereto, and may include other setting categories related to sound settings or screen settings within the electronic device.

According to another embodiment, the setting category list 315 may include a category that supports generation of a new avatar video.

In operation 230, the processor 120 may receive a user input (e.g., a touch or tap input via a touchscreen) selecting a setting category from among the setting category list 315 for which the avatar is to be customized by the electronic device 101.

In operation 240, responsive to selection of the setting category, the processor 120 may display a list of avatar videos (e.g., templates), each indicating a combination of preselected music, background sources, and avatar animations for ap[plication to the avatar video. For example, the processor 120 may download, from a server, an avatar video template including a particular animation/motion, a sound source, and a background source. The processor 120 may compare and analyze the motion animation information (e.g., a “bhv” file set) stored in the electronic device 101 and a database stored in the electronic device, so as to select a sound source (e.g., music) and a background source (e.g., an image or video) recommended for each motion. The processor 120 may recommend and provide (or retrieve) a first music and a first background source suitable for a first animation/motion based on the avatar video template, and recommend and provide (or retrieve) a second music and a second background source suitable for a second motion, to display the avatar video list.

According to an embodiment, based on selection of one of the avatar videos (e.g., templates) from the list, the processor 120 may configure (or generate) a corresponding avatar video, in which the preset sound source (e.g., music) and background source (e.g., an image or video), as paired with the corresponding avatar animation, are together automatically applied to the avatar.

Accordingly, the electronic device 101 may provide, to a user, custom avatar videos (e.g., personalized avatar videos), in which some may utilize the same animation information, but are customized so as to be different for each electronic device 101 due to recommendation of divergent backgrounds and the sound/music.

Additionally, the processor 120 may analyze spatial considerations in display of the avatar (e.g., an avatar size, a spatial position of the avatar within the user interface) suitable for the display size of the electronic device, in addition to the sound source and the background source. Based on the same, the processor 120 may recommend a particular avatar arrangement position, and apply the recommended position to the avatar video.

According to an embodiment, the processor 120 may receive (or download), from a server (e.g., an avatar service support server), an avatar video template to which a sound source and a background source are recommended and applied based on a respective motion or animation for the avatar, and may provide the received avatar video to a display list.

As an example, as shown in <302> of FIG. 3, the processor 120 may display a second screen 320 supporting a call setting, in response to selection of a call setting category. The second screen 320 may include an avatar 311, an avatar video list 330, a mute setting item 340 either inclusion or exclusion of music from the avatar media (e.g., sound or no-sound), and a background source setting item 345 for changing a background imagery displayed in the avatar showroom, a save item 347 (e.g., save), and a cancel menu. The save item (e.g., save) may be selectable save the avatar video being generated in the avatar showroom, or to enter the setting mode of the setting category.

According to an embodiment, the processor 120 may provide the avatar video list 330, which each video represented by a thumbnail. The avatar video list 330 may include thumbnails of avatar videos generated by the electronic device 101, and thumbnails of avatar videos downloaded from a server. In some embodiments, the avatar video list 330 may include avatar video (e.g., a template represented by a thumbnail) that can be downloaded from the server.

According to an embodiment, the processor 120 may, in response to receiving a drag input moving the avatar video list 330 in a first direction (e.g., rightwards) or in a second direction (e.g., leftwards), move the avatar video list 330 accordingly, to display avatar videos further “up” or “down” the sequence within the list 330.

In operation 250, the processor 120 may receive a user input selecting a first avatar video from the avatar video list.

According to an embodiment, the processor 120 may display (e.g., reproduce) a digital avatar, which may then be displayed in an avatar showroom space, based on a the selected first avatar video. For example, the processor 120 may animate the avatar with a first motion/animation included in the first avatar video, output a first music, and display a first background, in presenting the avatar showroom. Additionally, the processor 120 may adjust the size and position of the digital avatar within the showroom, based on an avatar arrangement structure recommended in association with the first avatar video. As an example, as shown in <302> of FIG. 3, in response to the selection of the first avatar video 331 from the avatar video list 330, the avatar 311 may be reproduced with the first animation included in the first avatar video, a recommended first background, and with output of the recommended first sound (e.g., first music) may.

According to an embodiment, in response to detecting a user input selecting the first avatar video 331, the processor 120 may provide a visual effect indicating that the first avatar video 331 has been selected, such as, for example, highlighting of the same in the form of a box or check mark (v), which may be displayed to the first avatar video 331.

According to an embodiment, when the processor 120 detections selection of a second avatar video from the avatar video list 330 illustrated via reference numeral <302>, the electronic device 101 may initialize (e.g., reset) the display of the first avatar video relating to the previous selection, and may display (e.g., or reproduce) the same digital avatar in the context of the selected second avatar video (e.g., swapping one or more of background, sound, and animation).

In operation 260, the processor 120 may configure (e.g., change) the selected first avatar video to a screen of the selected setting category. For example, the processor 120 may enter a setting mode for a selected setting category in response to detecting an input requesting execution of a save function, and configure the first avatar video selected in the setting mode as a screen of the setting category.

As an example, the processor 120 may enter a call setting mode in response to selection of the save item 347, and as shown in <303> of FIG. 3, the processor may switch to a call setting screen 350 for setting the first avatar video for display on the call screen. The call setting screen 350 may include a call screen 355 to which the first avatar video selected in the avatar video mode is applied, a playback on/off item 360 (e.g., selectable to enable or mute sound), and a setting approval item 370 (e.g., selectable to confirm and save the user's settings).

The processor 120 may be configured to, in response to the input for selection of the setting approval item 370, display the call screen 355 to which the first avatar video is applied at the time of call reception or transmission.

When receiving a call from the counterpart device, the processor 120 may display, on the display, a call screen 380 to which the first avatar video is applied, as shown in <304>of FIG. 3. The call screen 380 may display a reception approval item 381 and a reception rejection item 385. When a call is received, an avatar video may be reproduced on the call screen 380. For example, the processor 120 may display an avatar on the first background source based on the first avatar video configured as the call screen, and may output a first sound source while moving the displayed avatar in the first motion.

As another example, the processor 120 may configure the avatar video in a lock screen category. In a case of the lock screen category, even if an avatar video, that is, an avatar video including all of the motion, sound source, and background source, is configured, a mute option may be configured as a default for reproduction of the sound source.

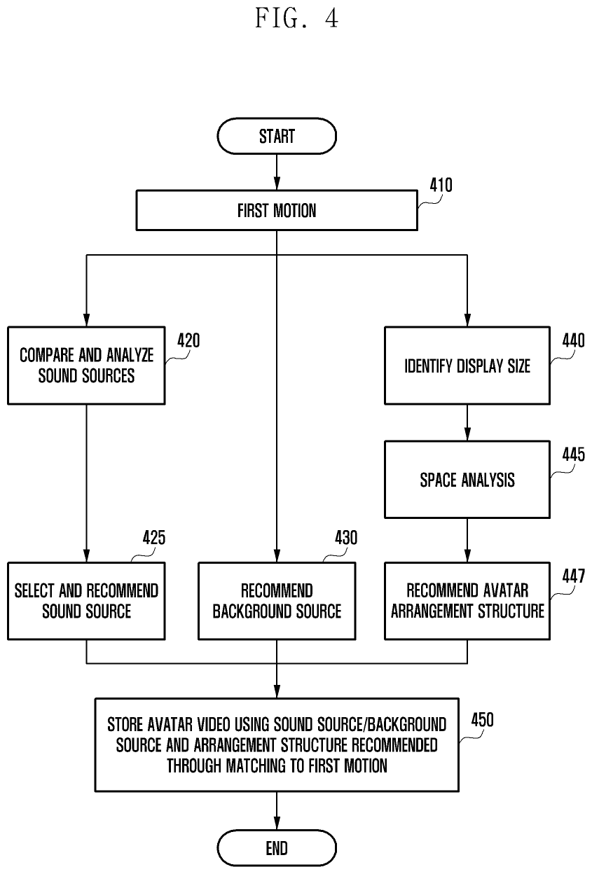

FIG. 4 is a flowchart illustrating an avatar video configuration operation in an electronic device according to an embodiment.

Referring to FIG. 4, according to an embodiment, the electronic device 101 may recommend a sound, a background, and an avatar arrangement matching each of a number of stored avatar animations (i.e., “motions”), configure (or generates) avatar videos including the recommended respective sounds, backgrounds , and avatar arrangements, and provide each of the generated avatar videos for population of an avatar video list.

As an example, the electronic device 101 may perform the operations of FIG. 4 for each motion in order to configure an avatar video. In operation 410, the processor 120 of the electronic device 101 may select one first motion (e.g., animation) from a motion database, and identify motion information (e.g., metadata) related to the first motion. The motion information may include at least one of a three-dimensional model to be applied to the face, the facial texture (e.g., information used to express the color or texture of the three-dimensional model), facial expression information, body motion information, body texture information, and bpm information according to the movement speed.

In operation 420, the processor 120 may compare and analyze the motion information and a sound source database stored in the electronic device 101, or a sound source database provided from a server. For example, the processor 120 may compare and analyze metadata of the selected first motion with metadata of a sound source (e.g., an mp3 file or a sound file).

In operation 425, as a result of the comparison and analysis, the processor 120 may select and recommend one or more sound sources detected as suitable for the selected first motion, based on the comparison and matching.

As an example, the processor 120 may identify the beats-per-minute (bpm) represented in a particular animation of the first motion (e.g., a dance), select a sound source having a matching bpm, and thus recommend the matching sound source.

As another example, the processor 120 may identify a music genre theme of the first motion, select a sound source having metadata matching the identified music genre theme (e.g., Jazz or Hip-Hop) or match identification information (e.g., a motion or dance name) of the selected motion to the sound metadata, such as the title, album, and artist name of the sound source, so as to develop a recommendation for the sound source.

According to an embodiment, when a plurality of sound sources are selected for the first motion, the processor 120 may select a single sound source based on a priority thereof. The priority may be based on, for example, a preset user preference, a count of a number of metadata items having similar information, and a count of a number of times that the sound has been historically requested for playback.

Independently or in parallel, in operation 430, the processor 120 may consider metadata of an image or video information stored in the electronic device 101 to generate a recommendation as to a background (or a background source, or a background image), which matches to the first motion or the recommended first music.

For example, if the music recommended for the first motion has metadata indicating a “summer” musical genre, the processor 120 may recommend a background source corresponding to a “summertime” image. Similar, some motions/animations may be associated with certain types of metadata. For example, when the degree of movement of the first motion is categorized in metadata as “slow,” the processor 120 may recommend a background source corresponding to “autumn,” based on a prior association thereof with “slow.”

Independently or in parallel, in operation 440, the processor 120 may identify the display size (e.g., the size of the display area). In operation 445, the processor 120 may analyze a screen space for display of the digital avatar, according to the display size. In operation 447, the processor 120 may recommend visual arrangement for the digital avatar (e.g., including an avatar size and position) according to the screen space.

According to some embodiments, operations 440 to 447 may be omitted. In operation 450, the processor 120 may configure (e.g., and/or generate) the avatar video based on a combination of the sound, the background, the arrangement, etc. as selected based on the first motion/animation.

According to an embodiment, the processor 120 may store the avatar video in the form of a package. For example, the processor 120 may associate and store a first music file, a first background source image, and an avatar arrangement structure, which are recommended in response to the first motion, and may call the first music file and the first background source image, which are stored in association with the first motion, at the time of providing the avatar video, and may dispose the avatar according to the arrangement structure data.

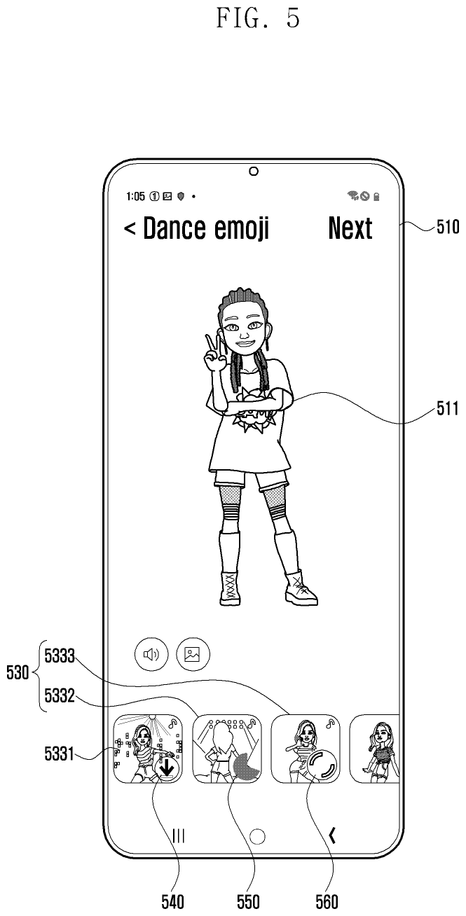

FIG. 5 is an example diagram illustrating providing of an avatar video list of an electronic device according to an embodiment.

Referring to FIG. 5, according to an embodiment, the processor 120 of the electronic device 101 may display a screen 510 including an avatar video list 530 (e.g., a first avatar video 5331, a second avatar video 5332, and a third avatar video 5333 are included) in an avatar video mode. The avatar video list may include multiple avatar video thumbnails. A current avatar 511 may also be displayed.

As an example, the avatar video list may be provided in the order of avatar videos recently generated first.

The processor 120 may display an identifier for distinguishing between a pre-produced avatar video, a downloaded avatar video, and an avatar video other than the pre-produced or downloaded avatar video.

As an example, when an avatar video (e.g., an avatar video template corresponding thereto) selected by a user from the avatar video list is to be downloaded, the processor 120 may display an identifier 540 in the form of a downward pointing arrow shape, which may indicate that the particular avatar video is downloadable from an external source.

As another example, the processor 120 may download an avatar video (e.g., an avatar video template corresponding thereto) from a server based on detecting a user request for the same, and may display an identifier 550 indicating that the corresponding avatar video is in the process of being downloaded. The processor 120 may further display an identifier 560 indicating that the download of the corresponding avatar is complete, and that the avatar video (or the avatar video template corresponding thereto) is ready to be applied (or being applied and/or prepared for execution) by the electronic device.

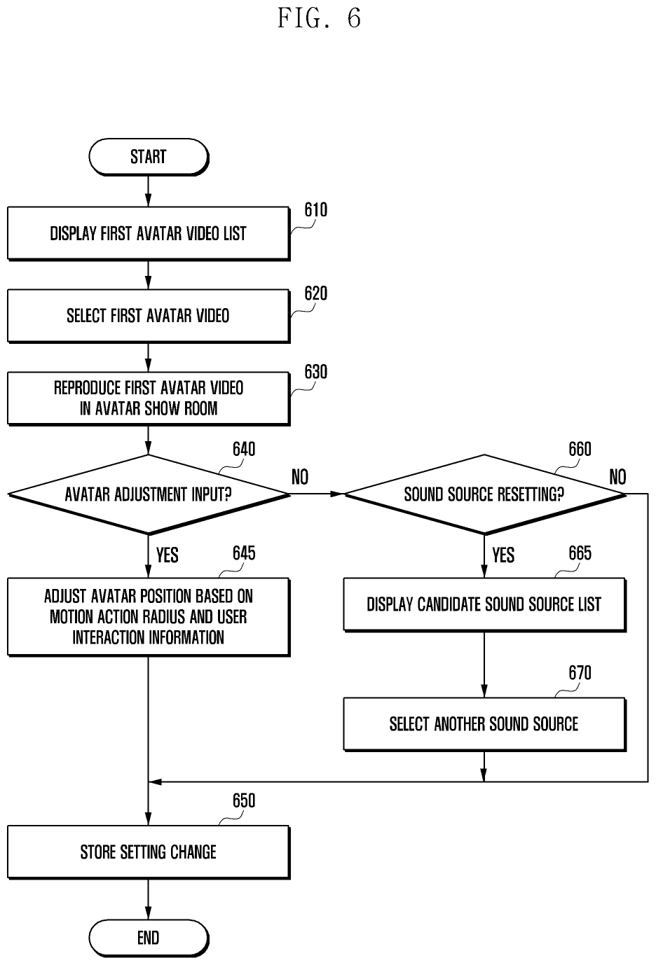

FIG. 6 is a flowchart illustrating an avatar video generation and editing operation of an electronic device according to an embodiment.

Referring to FIG. 6, according to an embodiment, the processor 120 of the electronic device 101 may display an avatar video list in an avatar video mode in operation 610. For example, the processor 120 may display an avatar video list including music and background sources recommended for each motion in the form of thumbnails.

Additionally, the processor 120 may analyze a space (e.g., an avatar size or a spatial position) suitable for the display size of the electronic device in addition to the sound source and the background source, recommend the avatar arrangement position, and apply the recommended avatar arrangement position to an avatar video.

According to an embodiment, the processor 120 may receive (or download) an avatar video template, to which a sound source and a background source are recommended according to each motion/animation thereof, from a server (e.g., an avatar service support server), and provide the received avatar video to the avatar video list.

In operation 620, the processor 120 may receive a user input selecting a first avatar video. In operation 630, the processor 120 may reproduce (or display) the selected first avatar video in an avatar showroom. For example, the processor 120 may animate the digital avatar using a first motion/animation indicated by the first avatar video, display a recommended background corresponding to the first motion, and output music also corresponding to the first motion.

In operation 640, the processor 120 may determine whether an avatar adjustment input is received for the displayed first avatar video. For example, a user may adjust the position of the avatar by touching the avatar, or may adjust the size of the avatar by executing a pinch-in or pinch-out operation on the avatar (e.g., via touch screen).

In operation 645, in response to receiving an input for adjusting the avatar, the processor 120 may adjust the position of the avatar based on the movements of the input (e.g., a drag input) and/or user interaction information (e.g., information on the movement of the touch/drag input). The processor 120 may then proceed to operation 650 and change the first avatar video setting based on the adjustments to size and/or position of the digital avatar, and store the same.

In operation 660, the processor 120 may determine whether a user input is detected requesting changing of the source. For example, the processor 120 may receive a user input for entering the sound source resetting mode. In operation 665, the processor 120 may enter a sound source setting mode, and display a list of candidate sound sources related to the first avatar video. The processor 120 may provide, on the screen, a list of candidate sound sources to be matched based on bpm information, genre theme information, and identification information of the first motion included in the first avatar video. In operation 670, the processor 120 may receive a user input selecting a new sound source. In operation 650, the first avatar video setting may be changed to indicate the newly selected sound source.

When the avatar adjustment input or the sound source resetting input is not received, the processor 120 may store the first avatar video being reproduced in the avatar showroom.

Although not shown in the drawing, the processor 120 may receive a user input requesting background source setting, and may change the background source setting related to the first avatar video displayed in the avatar showroom.

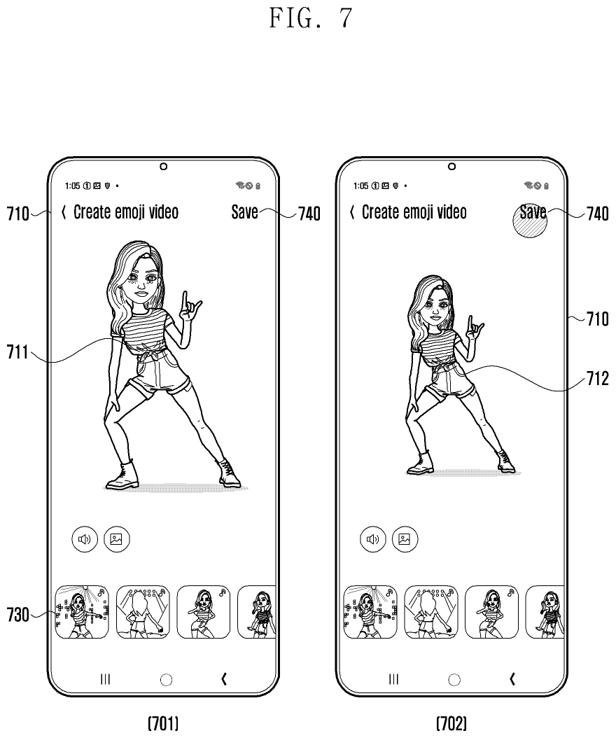

FIG. 7 illustrates an avatar video editing user interface environment of an electronic device according to an embodiment.

Referring to FIG. 7, the electronic device 101 according to an embodiment may support an avatar editing (adjustment) function in an avatar video mode.

In response to selection of a first avatar video, the processor 120 may display a first screen 710 for displaying (reproducing) an avatar in an avatar showroom space based on a first avatar video. For example, as shown in <701>, the processor 120 may animate a digital avatar 711 using a first motion/animation corresponding to the first avatar video selected from an avatar video list 730, display a background associated with the first motion, and output music associated with the first motion.

The processor 120 may receive a user gesture requesting adjustment of the size of the avatar 711 (e.g., a pinch-in gesture selecting or after selection of the avatar), and may display, in response to the user gesture, as shown in <702>, a size-adjusted avatar 712 based on the user gesture (e.g., a pinch-in results in a reduction in size).

In response to selection of a save item 740, the processor 120 may change and store the configuration of the size and position values of the avatar corresponding to the first avatar video.

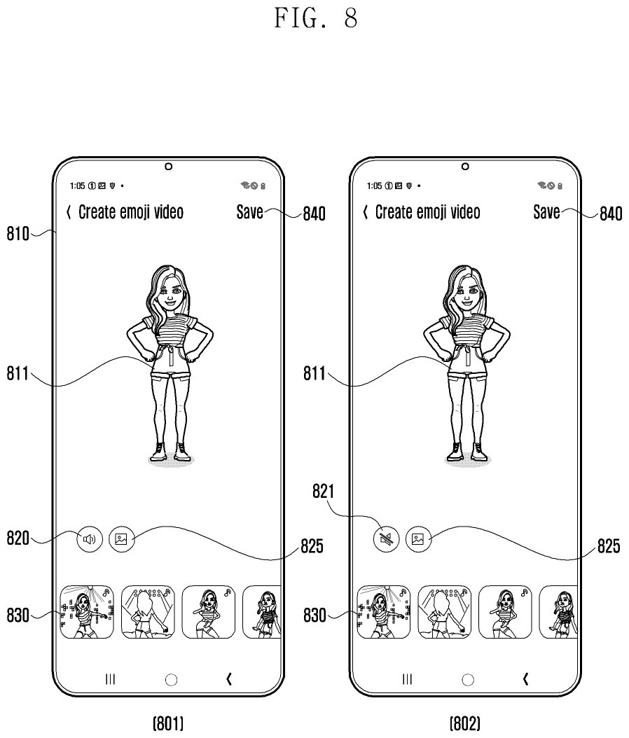

FIG. 8 illustrates an avatar video editing user interface environment of an electronic device according to an embodiment.

Referring to FIG. 8, the electronic device 101 according to an embodiment may support a mute function for the music recommended in an avatar video mode. In response to selection of a first avatar video, the processor 120 may display, as shown in <801>, a first screen 810 displaying (reproducing) a digital avatar 811 in an avatar showroom space based on the first avatar video. The first screen 810 may include an avatar video list 830, a mute item 820, a background source editing item 825, and a save item 840.

The processor 120 may display the mute item 820 in a visually distinguishable manner, which may be selectable to either enable to inclusion of sound or disable the inclusion of sound (e.g., muting) in the first avatar video. For example, the mute item 820 is deactivated such that output of sound is permitted, the mute item may be displayed as seen in the screen represented by numeral <801>.

In response to selection of the mute item 820, the processor 120 may display a visual modification of the mute item 820 as seen in reference numeral <802>, indicating activation of the mute function and suppression of sound. The processor 120 may resume output of the sound source in response to a user input re-selecting the mute item 820 again in reference numeral <802>, which may revert display of the mute item 820 to the visual configuration seen in <801>.

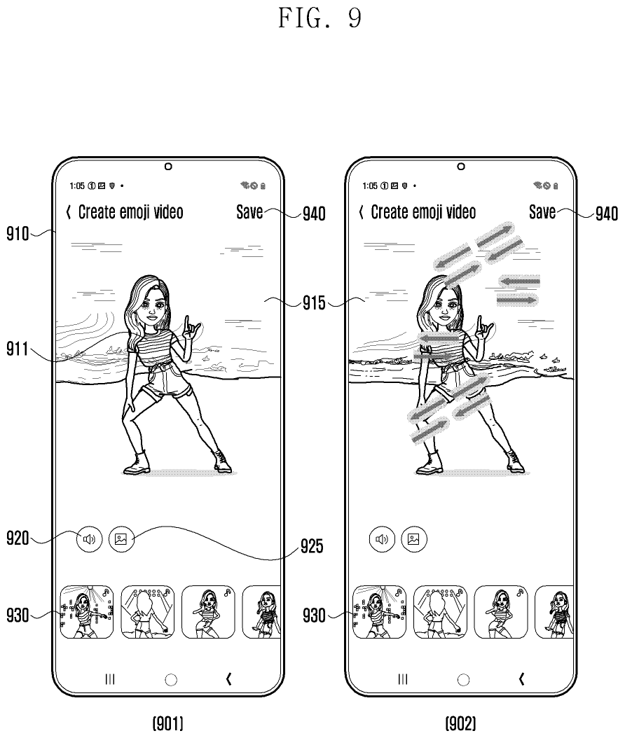

FIG. 9 illustrates an avatar video editing user interface environment of an electronic device according to an embodiment.

Referring to FIG. 9, the electronic device 101 according to an embodiment may support an editing function for a background source image recommended in an avatar video mode. In response to selection of a first avatar video, the processor 120 may display (e.g., reproduce), as shown in <901>, a digital avatar 911 in an avatar showroom space, based on a first avatar video. A first screen 910 may include an avatar video list 930, a mute item 920, a background source editing item 925, and a save item 940. The processor 120 may display a background source image 915 recommended based on the first avatar video on a first screen 910.

The processor 120 may enter a background source editing mode as illustrated in <901>, in response to selection of a background source editing item 925. In the background source editing mode, the processor 120 may be receptive to user inputs changing the background source image. The background source editing mode may support a background source image reduction/enlargement function and a background source image movement function, and additionally may support an avatar size reduction/enlargement function and an avatar movement function.

For example, a user may enlarge or reduce the size of the background source image (e.g., via the illustrated pinch-in and pinch-out inputs). The user may move the position of the background source image by dragging the background source image to one direction thereof via touch-based drag inputs, as illustrated.

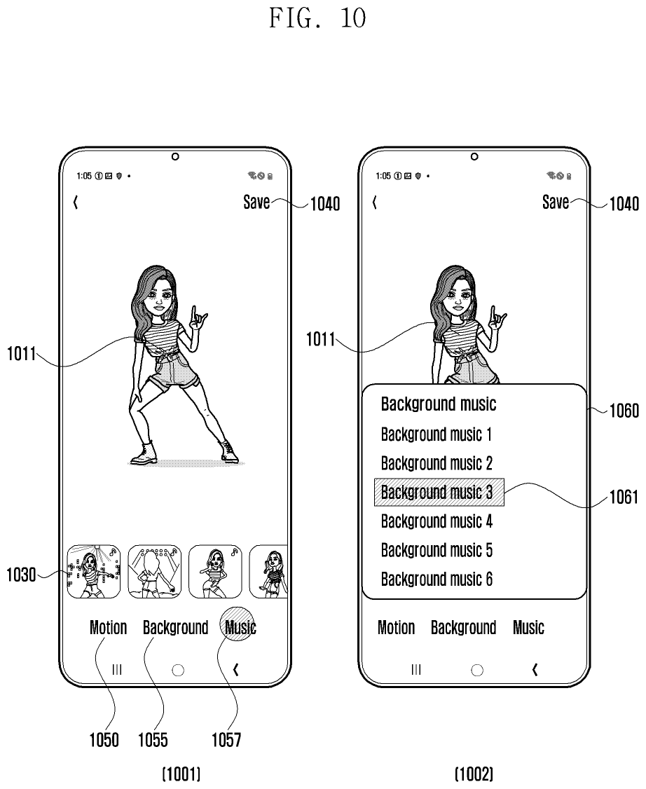

The processor 120 may change and store a background source editing setting corresponding to the first avatar video in response to selection of a save item 940. FIG. 10 illustrates an avatar video editing user interface environment of an electronic device according to an embodiment. Unlike FIGS. 7 to 9, the screen of FIG. 10 includes a motion editing item 1050, a background source editing item 1055, and a sound source editing item 1057 while excluding a mute item and a background source editing item, but the user interface environment is merely an example, and the motion editing item 1050, the background source editing item 1055, and the sound source editing item 1057 may be applied to another user interface environment as well.

Referring to FIG. 10, the electronic device 101 according to an embodiment may support editing (e.g., changing) a sound source recommended in the avatar video mode. In response to selection of the first avatar video, the processor 120 may display, as shown in <1001>, a first screen for displaying (reproducing) an avatar 1011 in the avatar showroom space based on a first avatar video. The first screen may include an avatar video list 1030, a motion editing item 1050, a background source editing item 1055, a sound source editing item 1057, and a save item 1040.

The processor 120 may provide a candidate sound source list 1060 related to the first avatar video on the first screen 1010, as shown in <1002>, in response to a user input selecting the sound source editing item 1057.

The processor 120 may reproduce the selected sound source upon detecting an input selecting another sound source 1061 from the candidate sound source list 1060. The processor 120 may express the items of the selected sound source and the unselected sound source to be visually distinguished (e.g., circle shape display or highlight display).

In response to selection of the save item 940, the processor 120 may perform change to another sound source selected from the candidate sound source list 1060 and store the same.

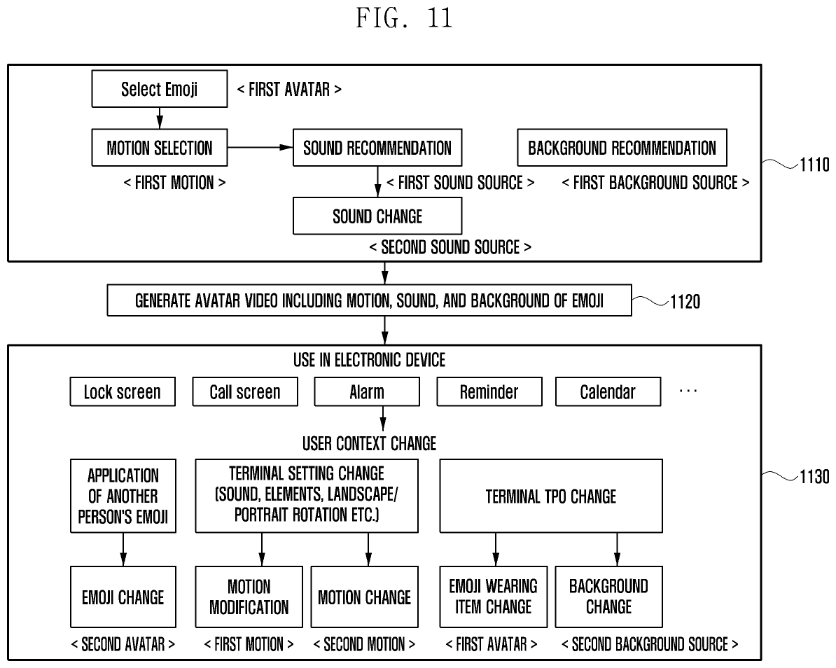

FIG. 11 is a context diagram illustrating an avatar service operation of an electronic device according to certain embodiments.

Referring to FIG. 11, according to an embodiment, the electronic device 101 may perform a first operation 1110, which details recommending a sound source and a background source for each motion/animation in order to configure a plurality of avatar videos, a second operation 1120 of generating (or configuring) an avatar video including the recommended motion, sound source, and background source for the digital avatar (e.g., emoji), and a third operation 1130 of actually using/displaying the generated avatar video in various apps (or screens, settings, etc.) as a decorative, aesthetic element of the electronic device, and optimizing and providing elements (e.g., a background source, a sound source, an avatar arrangement, or avatar information) included in the avatar video according to situation and according to context analysis.

When describing the first operation 1110, when an emoji (e.g., a first avatar) is selected to configure an avatar video and a motion (e.g., a first motion) is selected for the selected emoji, the electronic device 101 may analyze a sound source and background source database to recommend a sound suitable for the selected animation/motion (e.g., a first sound source) and recommend a background source (e.g., a second background source) suitable for the selected animation/motion. Although omitted from the drawings, the electronic device 101 may additionally recommend an avatar arrangement structure in response to the selected motion.

Optionally, when the user requests a sound change, the electronic device 101 may perform sound change (e.g., a second sound source). The electronic device 101 may apply the changed sound to the selected motion. Additionally, the electronic device 101 may support a function of changing the background source recommended for the selected motion, editing the background source, or editing the avatar.

The electronic device 101 may perform a first operation for each motion data stored in the electronic device.

When describing the second operation 1120, the electronic device 101 may generate an avatar video including the sound source and the background source, which are recommended in the first operation, and the selected motion. The electronic device 101 may configure an avatar video based on an avatar video template configured to include a motion, a sound source, and a background source, and store the same.

When describing the third operation 1130, the electronic device 101 may provide the avatar video to be used as various phone decoration elements of the electronic device. The electronic device 101 may access a setting mode of another app in the avatar video mode. The electronic device 101 may configure the avatar video as another app screen of the electronic device, for example, a lock screen, a call screen, an alarm screen, a reminder screen, and a calendar screen. The electronic device 101 may provide an option to select whether to use the avatar video on the description screen of each app.

The electronic device 101 may analyze the context according to the situation of the electronic device 101 and optimize and change the avatar video for the electronic device.

As an example, when an emoji (or avatar) corresponding to identification information of a counterpart device is present when receiving a call, the electronic device 101 may maintain other elements in the avatar video, for example, the background source and sound source, and may change the avatar to another person's avatar (e.g., a second avatar).

As another example, when the screen and sound-related settings (e.g., a landscape mode, a portrait mode, or sound change) of the electronic device 101 are changed, the electronic device 101 may alter the selected motion or change the selected motion to another motion.

As another example, when the current time, a place in which the electronic device is located, and an occasion are changed, the electronic device 101 may recommend an avatar's accessories (e.g., wearing items) suitable for the time, the place, and the occasion, may perform change to the recommended accessory, or may perform change to a background image suitable for the time, the place, and the occasion.

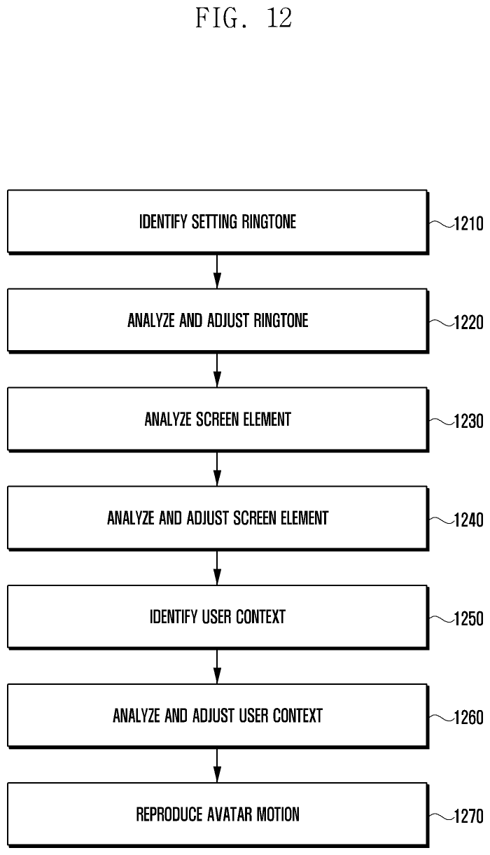

FIG. 12 is a flowchart illustrating an operation of customizing an avatar video according to a user context of an electronic device according to certain embodiments.

Referring to FIG. 12, according to an embodiment, the electronic device 101 may analyze app setting information, elements of a UI screen, and a context of the electronic device to automatically adjust elements of an avatar video to provide a user-customized avatar video.

For example, in operation 1210, the processor 120 may identify a ringtone (e.g., a sound source) of a sound setting previously configured in the electronic device. For example, the ring tone may denote an audio notification generated by the electronic device 101 when an incoming call is received.

In operation 1220, the processor 120 may adjust the avatar video element (e.g., motion speed) by analyzing the ring tone configured in the electronic device 101. For example, the processor 120 may analyze the ring tone set for each contact in the user's phonebook, and an alarm sound designated in a call setting, and analyze the movements of an animation/motion included in the avatar video.

As an example, the processor 120 may analyze a ring tone to determine a movement speed of the animation, including start and end points thereof, which might best optimize the animation for the ring tone. The processor 120 may adjust the avatar animation/motion to move at a speed that thus corresponds to a beat of the analyzed ring tone. As another example, the processor 120 may adjust the avatar motion reproduction speed.

Independently or in parallel, in operation 1230, the processor 120 may analyze a user interface (UI) element of the screen of the electronic device to which the avatar video is applied, and in operation 1240, the processor may adjust elements of the avatar video according to the screen UI element.

As an example, the processor 120 may determine the position and size at which an avatar is to be displayed by analyzing the positions of a call screen UI object selected by the user, and lock screen UI objects configured by the user in the call background source. As another example, the processor 120 may adjust the size and position of the avatar when the animation causes the digital avatar to exceed the display area of the display, by analyzing a potential radius of action of the avatar's animation, and the usable display size (e.g., the size of the display area).

Independently or in parallel, in operation 1250, the processor 120 may identify a user context according to the electronic device situation. For example, the electronic device 101 may identify whether a landscape mode or a portrait mode is currently active, and a present screen resolution.

In operation 1260, the processor 120 may adjust the elements of the avatar video based on the various analyses of the user context. As an example, when the display mode is changed to the landscape mode, the processor 120 may determine a position and size at which the avatar is to be displayed according to the landscape mode change, and may adjust the position and size accordingly.

In operation 1270, the processor 120 may reproduce the avatar video with the adjusted elements.

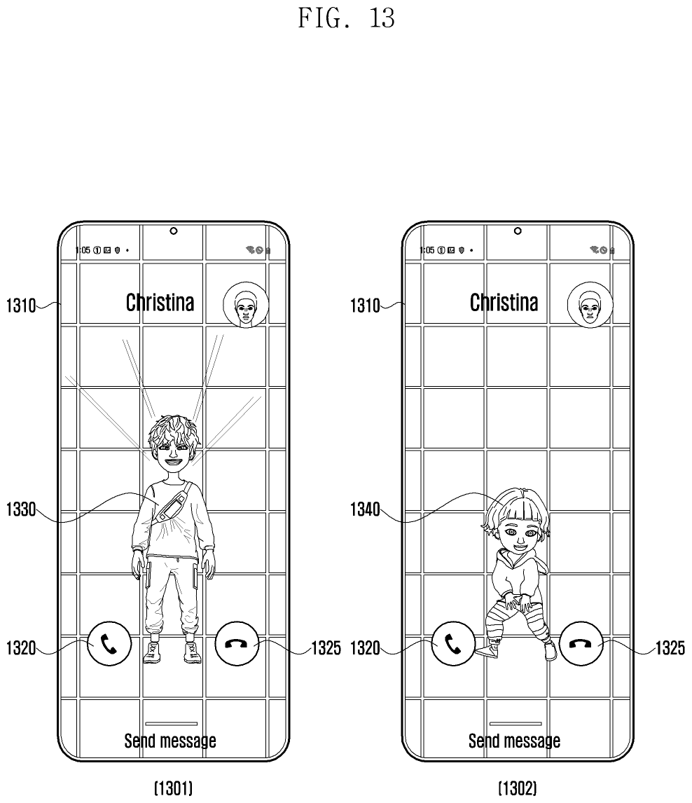

FIG. 13 illustrates an avatar video user interface environment of an electronic device according to certain embodiments.

Referring to FIG. 13, the electronic device 101 according to an embodiment may adjust and express an avatar video, which is configured on a call screen, for each occasion according to user context.

The electronic device 101 may configure a call screen 1310 as an avatar video shown in <1301>. The call screen 1310 may include an avatar 1330, the motion of which is to be reproduced by the configured avatar video, a reception approval object 1320, and a reception rejection object 1325.

Based on reception of a call from a counterpart device, the electronic device 101 may identify whether a counterpart avatar exists in response to identification information of the counterpart device, and if the counterpart avatar exists, the electronic device 101 may display, as shown in <1302>, the call screen 1310 by replacing the digital avatar with the detected counterpart avatar 1340. The electronic device 101 may maintain settings for a motion, a background source, and music of the original avatar video, while replacing the digital avatar with the counterpart avatar.

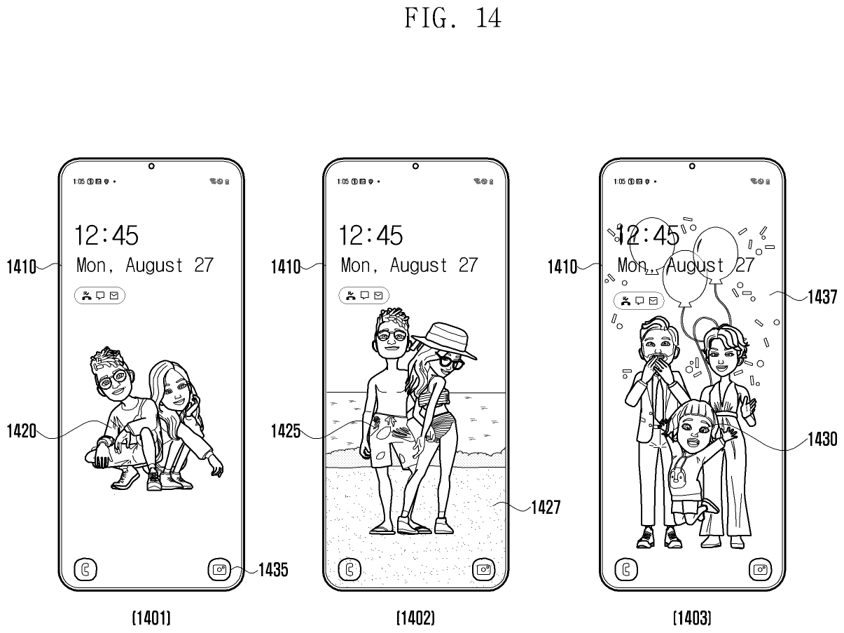

FIG. 14 illustrates an avatar video user interface environment of an electronic device according to certain embodiments.

Referring to FIG. 14, the electronic device 101 according to an embodiment may change avatar clothes, motions, background sources, and accessories according to a current time, a place in which the electronic device 101 is located, and an occasion.

The electronic device 101 may configure a lock screen 1410 as an avatar video shown in <1401>. The lock screen 1410 may include an avatar 1420 to be reproduced by the avatar video, an emergency call item 1430, and a camera item 1435.

For example, when the electronic device 101 analyzes a present location and a user's stored schedule, and determines that the electronic device is located in a geographic area preset to correspond to metadata tags like “summer” or “recreation,” the electronic device may recommend stylistic item 1425 (e.g., accessories or clothes) suitable for the metadata tags (e.g., “resort”) change the digital avatar to wearing the stylistic items 1425 for the avatar, recommend usage of a new background image 1427 corresponding to the tags “summer” or “recreation” and change to the new background image 1427, as shown in <1402>.

As another example, the electronic device 101 may analyze a user's calendar to determine that a current date corresponds to a birthday or anniversary, and accordingly, the electronic device 101 may alter the digital avatar 1420 to reflect the scheduled anniversary on the lock screen 1410. Further, the electronic device 101 may add a celebratory animated visual effect 1437 thereon, as shown in <1403>.

As another example, when the electronic device is determined to be located in a corporate work setting according to the position information, the electronic device 101 may transform the avatar video configured on the lock screen into an avatar wearing items suitable for a professional setting and display the same, and when the electronic device is located at home, the electronic device may change the digital clothing to items suitable for home, and display the same. Alternatively, when it is determined that it is raining or snowing outside based on weather information, the electronic device 101 may add a snow effect or a rain effect to the background source image of the avatar video configured on the lock screen and display the same.

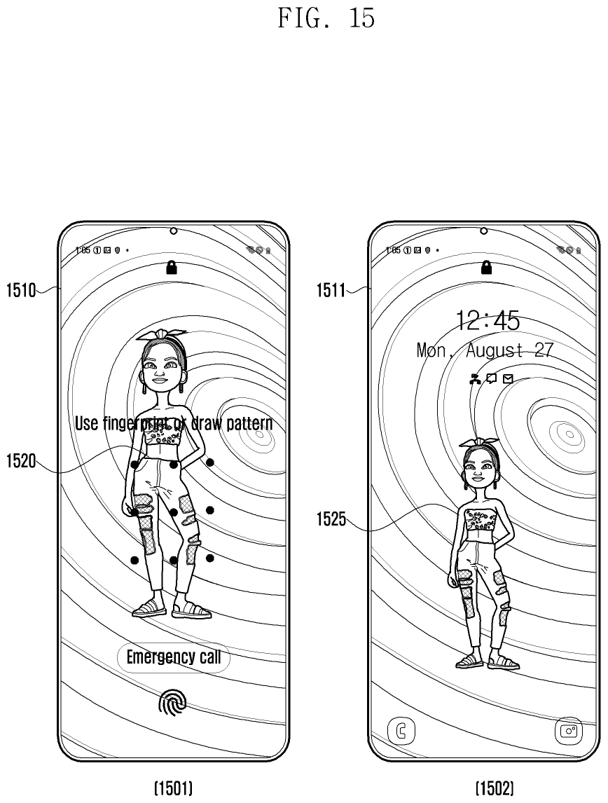

FIG. 15 illustrates an avatar video user interface environment of an electronic device according to certain embodiments.

Referring to FIG. 15, in response to changes in screen UI object configurations, the electronic device 101 according to an embodiment may apply and change an avatar arrangement structure suitable for a screen UI object change.

As shown in <1501>, the electronic device 101 may configure a unlock screen 1510 using the configured avatar video. The electronic device 101 may recommend and display an arrangement structure of the size and position of an avatar 1520 according to UI objects on the unlock screen.

When the electronic device 101 displays a lock screen 1511 as shown in <1502>, sometimes the location, type, and size of UI objects included in the lock screen 1511 will change. Accordingly, the electronic device 101 may analyze the UI objects on the screen and automatically adjust display size and position of the digital avatar 1525 elements so as to avoid overlap with the UI objects included on the screen.

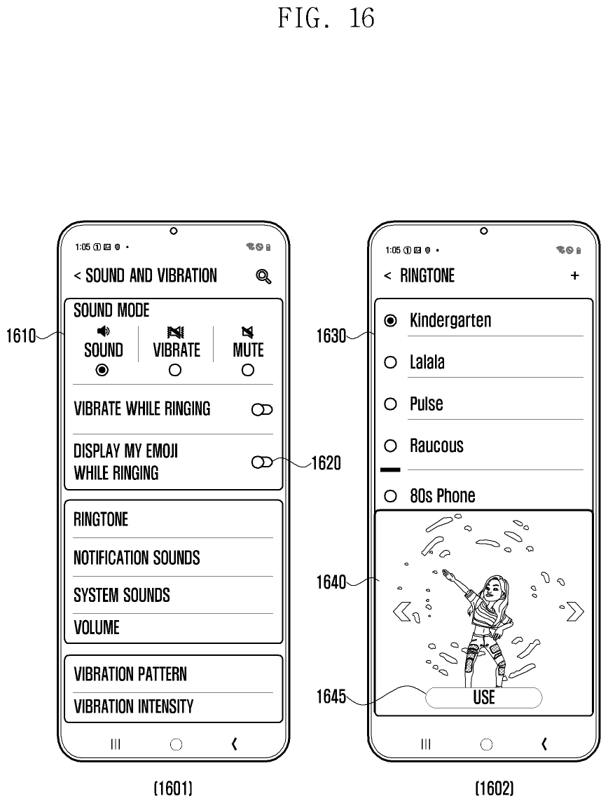

FIG. 16 illustrates an avatar video user interface environment of an electronic device according to certain embodiments.

Referring to FIG. 16, the electronic device 101 according to an embodiment may provide an avatar video application on/off function option in a sound setting mode of the electronic device 101.

As shown in <1601>, the electronic device 101 may enter the sound setting mode of the electronic device and display a sound setting screen 1610. The sound setting screen 1610 may include various setting items related to sound setting of the electronic device, and may include an avatar video setting item 1620 as shown.

When a user wants to apply the avatar video on a call screen, the user may select and activate the avatar video setting item 1620.

In response to the selection of the avatar video setting item 1620 on the sound setting screen 1610, the electronic device 101 may provide a ring tone list 1630 as shown in <1602>. When a first ring tone (e.g., a bell sound) is selected from the ring tone list 1630, the electronic device 101 may provide a recommendation UI 1640, in which an animation/motion and a background for the digital avatar suitable for the selected first ring tone are combined.

For example, when the first ring tone corresponds to a joyful theme, the electronic device 101 may recommend, as the avatar video, a background including a multitude of celebratory, animated elements and a correspondingly happy, energetic animation. As another example, if a second ring tone corresponds to a “calm” theme, the electronic device 101 may recommend, as the avatar video, a background source having a “nature” theme in tandem with gentle, slower animations/motion.

According to an embodiment, the electronic device 101 may analyze a bpm information of the selected ring tone (e.g., the first ring tone) to recommend a motion in a range similar to the bpm, and may adjust the movement speed of the motion so as to be optimized for the bpm of the motion.

The electronic device 101 may display a motion and a background source recommended in different combinations in response to an input for selection of arrow items from the recommendation UI 1640.

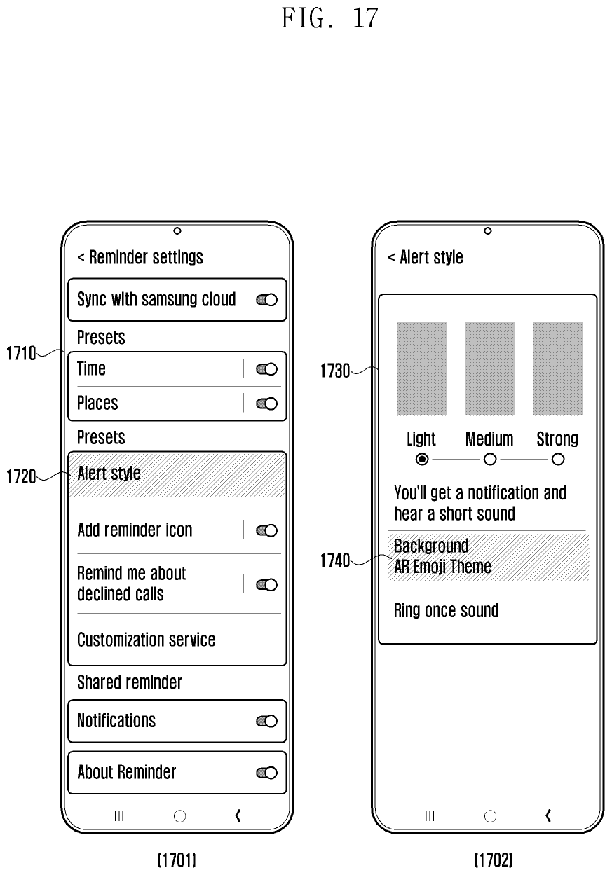

The electronic device 101 may configure, as the avatar video, the motion and background source currently being reproduced in the recommendation UI 1640 together with the selected first ring tone in response to the selection of a use item 1645 included in the recommendation UI 1640. The electronic device 101 may reproduce the avatar video configured in the sound setting mode when receiving a call. FIG. 17 illustrates an avatar video user interface environment of an electronic device according to certain embodiments.

Referring to FIG. 17, the electronic device 101 according to an embodiment may provide an avatar video application on/off function option in a reminder alarm (e.g., notification) setting mode of the electronic device 101.

As shown in <1701>, the electronic device 101 may enter a reminder notification setting mode of the electronic device 101 and display a reminder setting screen 1710. The reminder setting screen 1710 may include various setting items related to the reminder notification setting of the electronic device, and may include a notification style setting item 1720 as shown.

In response to the selection of the notification style setting item 1740 on the reminder notification setting screen 1710, the electronic device 101 may provide a notification style list 1730 as shown in <1702>. The electronic device 101 may provide a notification background source item 1740 in a notification style list 1730, and may provide a function of activating application of an avatar video in a notification background source item 1740 (e.g., “AR” emoji theme). Although not shown in the drawings, the electronic device 101 may provide a recommendation UI (e.g., referring to 1640 of FIG. 16) including a motion and a background source recommended for the set ring tone in response to the selection of the notification background source item 1740.

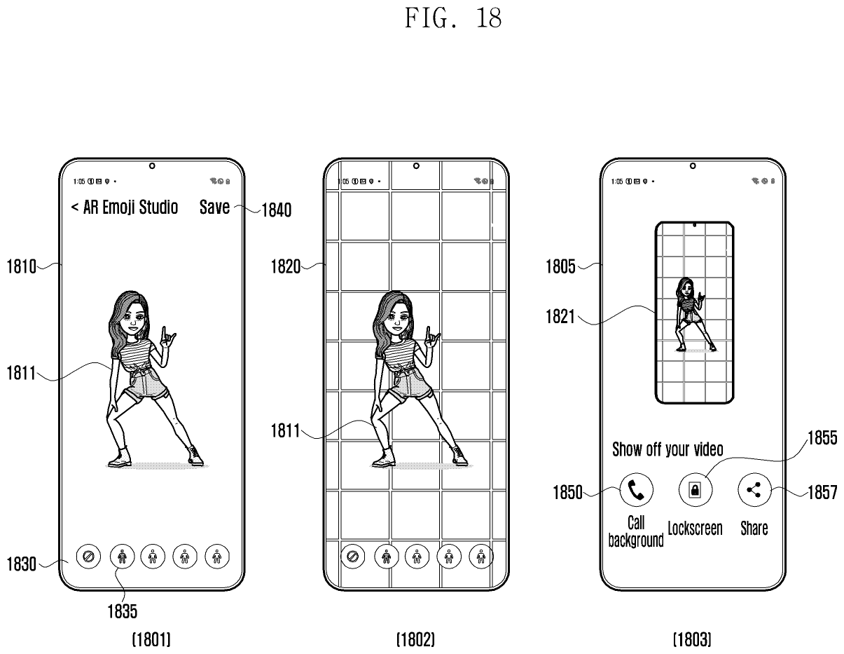

FIG. 18 illustrates an avatar video user interface environment of an electronic device according to certain embodiments.

Referring to FIG. 18, the electronic device 101 according to an embodiment may select a motion from a motion list to generate a new avatar video, and then may provide a setting category to support a function of setting each screen.

As an example, the processor 120 of the electronic device 101 may provide a new avatar video generation item in an avatar service mode, and based on the selection of the new avatar video generation item, may provide a first screen 1810 including a motion list 1830 as shown in <1801>. In response to selection of a first motion 1835 from a motion list 1830 of the first screen 1810, the processor 120 may automatically recommend a background source and a sound source in response to the first motion, may display the recommended background source in the avatar showroom, and may switch to a second screen 1820 for outputting a sound source, as shown in <1802>, while animating an avatar 1811 using the selected first motion.

In response to the selection of a save item 1840, the processor 120 may generate an avatar video including a first motion of the avatar 1811 currently reproduced in the avatar showroom and a background source and music recommended in response to the first motion, and, as shown in <1803>, the processor 120 may display a third screen 1805 for configuring the generated avatar video. The third screen 1805 may provide a thumbnail 1821 for the generated avatar video, and a setting category item to which the generated avatar video is to be applied, for example, a call setting item 1850, a lock screen setting item 1855, and a sharing item 1857. The setting category is not limited thereto, and may be provided as individual social network service items (e.g., Facebook items, Twitter items, Instagram items) for sharing.

According to an embodiment, the electronic device 101 may additionally provide the sharing function for the avatar video provided in the avatar service mode to various user interface environments (e.g., a call setting screen or a separate sharing menu option), and there is no limitation thereto.

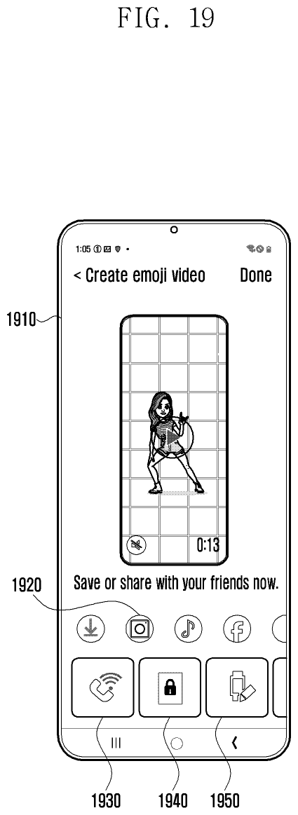

FIG. 19 illustrates an avatar video user interface environment of an electronic device according to certain embodiments.

Referring to FIG. 19, the electronic device 101 according to an embodiment may support a function of setting each screen by providing a setting category after generating a new avatar video.

As an example, in response to completion of generation (or save) of a new avatar video in an avatar service mode, the processor 120 of the electronic device 101 may provide a setting screen 1910 including a sharing item 1920 by which an avatar video can be shared and a setting category (e.g., a call setting item 1930, a lock setting item 1940, and a watch setting item 1950).

For example, the processor 120 of the electronic device 101 may enter a new video setting mode and provide the avatar video list 330 of FIG. 3 or the motion list 1830 of FIG. 18. In response to selection of completion of generation of the avatar video (that is, including music and a background source recommended in response to a first motion) selected according to the user's request, the processor 120 may provide a sharing item and a setting category for setting each screen. When a first item among the sharing items is selected, the processor 120 may enter a sharing mode related to the selected first item. When a call setting item 1930 is selected from the setting category, the processor 120 may set a call screen using an avatar video displayed on the setting screen.

A method of operating an avatar video service of an electronic device according to certain embodiments may include providing a screen setting category in an avatar video mode when an avatar service is executed, providing an avatar video list obtained by combining at least one of a sound source, a background source, and an avatar arrangement structure, which are recommended for each avatar motion, in response to selection of a first screen setting category from the screen setting category, and configuring a screen of the selected first screen setting category such that a first avatar video is reproduced, in response to selection of the first avatar video from the avatar video list.

The providing of the avatar video list may include providing, in the form of thumbnails, avatar videos configured by combining a sound source and a background source for each motion based on an avatar video template configured to include a motion, a sound source, and a background source.

The providing of the avatar video list may further include recommending a sound source suitable for each motion by comparing each piece of motion information with a sound source database stored in the memory, and recommending a background source image suitable for motion information stored in the memory from an image database stored in the memory, so as to configure the avatar video.

The providing of the avatar video list may further include receiving, from a server, an avatar video package to which music and a background source recommended for each motion are automatically applied, and providing the received avatar package to the avatar video list.

The screen setting category may include at least one of a call screen setting item, a lock screen setting item, a reminder notification screen setting item, a background source screen setting item, an alarm screen setting item, and a sharing setting item.

The method may further include displaying a screen on which an avatar video is configured after performing configuration such that the first avatar video is reproduced, such that the displaying of the screen on which the first avatar video is configured includes at least one of operations of performing a mute activation function based on at least one of position information of user interface objects arranged on the screen on which the first avatar video is configured, and usage context situation information, time information, position information, and schedule information of the electronic device, adjusting and displaying the size and position of an avatar included in the first avatar video, and adjusting and displaying the size and position of a background source included in the first avatar video.

As used in connection with certain embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Certain embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device #01) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to certain embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to certain embodiments, each component (e.g., a module or a program) of the above-described components may include a single entity or multiple entities, and some of the multiple entities may be separately disposed in different components. According to certain embodiments, one or more of the above-described components may be omitted, or one or more other components may be added. Alternatively or additionally, a plurality of components (e.g., modules or programs) may be integrated into a single component. In such a case, according to certain embodiments, the integrated component may still perform one or more functions of each of the plurality of components in the same or similar manner as they are performed by a corresponding one of the plurality of components before the integration. According to certain embodiments, operations performed by the module, the program, or another component may be carried out sequentially, in parallel, repeatedly, or heuristically, or one or more of the operations may be executed in a different order or omitted, or one or more other operations may be added.

1. An electronic device, comprising:
a display;
at least one processor; and
a memory storing instructions and a digital avatar,
wherein the instructions are executable by the processor to cause the electronic device to:
execute an avatar service application as part of a video avatar mode, and display a user interface of the avatar service application to the display, including a plurality of screen setting categories;
detect selection of a first screen setting category from among the plurality, and based on the detected selection, display an avatar video list including a plurality of avatar videos; and
based on detecting selection of a first avatar video among the avatar video list, apply the first avatar video to a screen of the selected first screen setting category,
wherein each avatar video is composed based on a template combined with at least a sound, a background, and an arrangement of a stored digital avatar as recommended for a first animation.

2. The electronic device of claim 1, wherein the instructions are further executable by the at least one processor to generate each of avatar videos by combining a motion, a sound source, and a background source based on each of avatar video templates designated to include a motion or animation data, a sound source data, and a background image, and provide the generated avatar videos in the form of a thumbnail to the avatar video list.

3. The electronic device of claim 2, wherein the memory stores a plurality of motions or animations, a sound source database, and an image source database, and
wherein the instructions are further executable by the at least one processor to:
automatically select a respective sound for each respective motion or animation based on the sound source database; and
automatically select a respective background source image for each respective motion or animation based on the image source database.

4. The electronic device of claim 1, wherein the instructions are further executable by the at least one processor to:
display, within the avatar video list, an avatar video package to which packaged music and a packaged background for each of a plurality of prestored motions or animations are automatically applied.

5. The electronic device of claim 1, wherein the screen setting categories include at least one of: a call screen category, a lock screen category, a reminder notification category, a background category, an alarm category, and a sharing category, and
wherein the instructions are further executable by the processor to:
in response to detecting a user input requesting activation of an individual setting mode for each screen setting category, display the individual setting mode on the display, detect selection of a particular avatar video based on a second user input, and initiate configuration of the selected particular avatar video.

6. The electronic device of claim 3, wherein each of the plurality of motions or animations includes metadata, and comparing each of the plurality of motions or animations to the sound source database further includes at least one of: comparing beats-per-minute (bpm) of each sound source to each motion or animation, comparing a music genre of each sound source to each metadata, and comparing identification information of each source to each metadata, and
wherein when multiple sound sources are detected as matching a particular motion or animation, a final sound source is selected from among the multiple sound sources based on a priority thereof,
wherein the priority is based on at least one of: a preset preference, an order in which the metadata is compared, and a count of a total number of times that each of the multiple sound sources is historically selected for playback.

7. The electronic device of claim 1, wherein the instructions are further executable by the at least one processor to:
identify a size of the display; and
determine a spatial region within the display to which the digital avatar is to be displayed according to the identified display size,
wherein generating the first avatar video includes changing a size and a position of the digital avatar for display on the display based at least in part on the determined spatial region.

8. The electronic device of claim 1, wherein the instructions are further executable by the at least one processor to:
after initiating playback of the first avatar video in a video reproduction mode, execute an avatar editing function as part of the video reproduction mode;
receive one or more user inputs changing at least one of:
a size and a position of the digital avatar within the first avatar video,
a sound of the first avatar video, and
a background displayed in the first avatar video.

9. The electronic device of claim 1, wherein
when the first screen setting category of the first avatar video is a lock screen category or a background screen category, a mute is set as at least one sound for generating the first avatar video.

10. The electronic device of claim 1, wherein the instructions are further executable by the at least one processor to:
display the generated first avatar video, on a user interface screen including a plurality of user interface objects; and
adjust at least one of a size of the digital avatar, a position of the digital avatar, a size of the background, and a position of the background, to facilitate display of the plurality of user interface objects.

11. The electronic device of claim 1, wherein the instructions are further executable by the at least one processor to:
display the generated first avatar video;
determining a usage context of the electronic device, and executing at least one of:
setting a mute function for playback of the first avatar video based on the determined usage context,
adjusting a size and a position of the digital avatar included in the first avatar video according to the determined usage context, or
adjusting a size and a position of the background according to the determined usage context.

12. The electronic device of claim 1, wherein the instructions are further executable by the at least one processor to:
display a customization screen in which the first avatar video is configurable, including one or more of: changing a costume of the digital avatar, changing the background, changing accessories included in the first avatar video from a first set of accessories previously set according to time, position and schedule information to a second set of accessories; and
displaying changes to the first avatar video set within the customization screen.

13. The electronic device of claim 1, wherein the instructions are further executable by the at least one processor to:
display a new avatar video generation item in the avatar video mode;
detect selection of the new avatar video generation item, based on the selection, display the avatar video list;
detecting selection of a second avatar video template from the avatar video list, displaying sharing items and the plurality of screen setting categories for configuring generation of a second avatar video.

14. The electronic device of claim 1, wherein the instructions are further executable by the at least one processor to:
display a new avatar video generation item in the avatar video mode;
detect selection of the new avatar video generation item, and based on the selection, display a motion list or an animation list;
based on detecting selection of a second motion from the motion list or the animation list, generate a second avatar video based on combination the second motion with the background and the sound recommended for a first motion, and
after storing the generated second avatar video, displaying sharing items and the plurality of screen setting categories selectable to further configure the generated second avatar video.

15. A method of an electronic device, the method comprising:
executing, by at least one processor, an avatar service application as part of a video avatar mode, and displaying, via a display, a user interface of the avatar service application, including a plurality of screen setting categories;
detecting, via input circuitry, selection of a first screen setting category from among the plurality, and based on the detected selection, displaying an avatar video list including a plurality of avatar videos; and
based on detecting selection of a first avatar video among the avatar video list, applying the first avatar video to a screen of the selected first screen setting category,
wherein each avatar video is composed based on a template combined with at least a sound, a background, and an arrangement of a stored digital avatar as recommended for a first animation.

16. The method of claim 15, wherein the avatar video list further comprises:
generating each of avatar videos by combining a motion, a sound source, and a background source based on each of avatar video templates designated to include a motion or animation data, a sound source data, and a background image, and provide the generated avatar videos in the form of a thumbnail to the avatar video list.

17. The method of claim 16, wherein a plurality of motions or animations, a sound source database, and an image source database are stored in a memory, and the method further comprises:
automatically selecting a respective sound for each respective motion or animation based on the sound source database; and
automatically selecting a respective background source image for each respective motion or animation based on the image source database.

18. The method of claim 16, further comprising:
display, within the avatar video list, an avatar video package to which packaged music and a packaged background for each of a plurality of prestored motions or animations are automatically applied.

19. The method of claim 15, wherein the screen setting categories include at least one of: a call screen category, a lock screen category, a reminder notification category, a background category, an alarm category, and a sharing category.

20. The method of claim 15, further comprising:
after generating the first avatar video, displaying an editing screen on which the first avatar video is further configurable,
wherein the displaying the editing screen further includes at least one of:
setting a mute function for playback of a first avatar video, based on at least one of relative positions of user interface objects displayed with the first avatar video, and a determined usage context in which the first avatar video is displayed, a present time, a present location of the electronic device, and a schedule as stored in the electronic device,
adjusting a size and a position of the digital avatar included in the first avatar video, and
adjusting a size and a position of the background included in the first avatar video.
